(19) United States
(12) Patent Application Publication
(10) Pub. No.: US 2025/0199307 A1
(43) Pub. Date: Jun. 19, 2025

(54) TRANSPARENT DISPLAY

(71) Applicant: Carl Zeiss Jena GmbH, Jena (DE)

(72) Inventors: Xiang LU, Oberkochen (DE); Martin THOM, Jena (DE); Marc JUNGHANS, Jena (DE)

(21) Appl. No.: 18/849,601

(22) PCT Filed: Mar. 21, 2023
(86) PCT No.: PCT/EP2023/057200

§ 371 Date: Sep. 23, 2024

(30) Foreign Application Priority Data
Mar. 31, 2022 (DE) 10 2022 107 677.6

(51) Int. Cl. G02B 27/01

(52) U.S. Cl. CPC G02B 27/0103

(57) ABSTRACT

A transparent display, comprising a holographic diffuser extending substantially in a two-dimensional diffuser plane, and comprising an enlarging reflective element, wherein the holographic diffuser and the reflective element are part of a one-piece optical unit, and wherein image rays, reflected by the reflective element, are guided inside the optical unit to the holographic diffuser.

### TECHNICAL FIELD

The present disclosure relates to transparent displays.

Many fields of application require very large-format displays. Displays comprising a projector with a picture generating unit and a screen are used for example in lecture or conference rooms. Short-distance projectors are increasingly being used, such as those disclosed in U.S. Pat. No. 10,067,324 B2 and WO 2018/117210 A1. A short-distance projector can also be arranged between the presenter and the screen in smaller rooms so that the presenter can move freely in the room without getting in the way of the light beams from the projector to the screen.

There is an increasing need for transparent displays. Transparent displays can provide a viewer with very immersive and augmented reality (AR) experiences. Transparent displays can be realized by means of transparent OLED displays embedded in glass substrates. The production of large transparent displays based on OLED displays is very costly. In addition, they are usually not sufficiently robust for use in harsher environments. Furthermore known are head-up displays in which images are projected onto transparent substrates, so that the images are reflected at the substrate and the viewer can visually perceive the images and simultaneously the environment which appears to be behind the substrate from their point of view. For example, head-mounted, transparent displays are described in documents EP 3 320 384 B1, US 2011/0 164 294 A1, US 2010/0 066 926 A1, and US 2008/0 186 547 A1. In addition, head-up displays for use in vehicles are described in DE 10 2019 206 025 A1.

Head-up displays typically have a limited field of view, and the so-called eyebox, i.e. the volume in which the eyes of the viewer must be located in order to be able to perceive the projected images, is limited. This is not a problem in vehicles, as the lateral position of the driver in relation to the head-up display is predetermined by the position of the seat. The vertical position of the eyes is also substantially fixed, as the seat height has been adjusted by the driver in such a way that they have the best possible all-round visibility.

The requirements for large-format displays are therefore fundamentally different from those for vehicle head-up displays or for head-mounted AR displays. In particular, uniform illumination with sufficient intensity represents a major challenge for large-format displays.

### BRIEF SUMMARY OF THE INVENTION

Based on this, the object of the present invention is to provide a cost-effective, in particular large-format, transparent display with a large field of view and a large eyebox.

According to the invention, this object was achieved by a transparent display as claimed in the main claim and by the method as claimed in the coordinate claim. Advantageous refinements of the transparent display are specified in the dependent claims.

Proposed is a transparent display having a holographic diffuser extending substantially in a two-dimensional diffuser plane, and having an enlarging reflection element, wherein the holographic diffuser and the reflection element are part of a one-piece optical unit, wherein image rays reflected by the reflection element are guided within the optical unit to the holographic diffuser.

In exemplary embodiments, the proposed transparent display can achieve a transparency of more than 50 percent, which is typically unattainable with conventional transparent OLED displays. The proposed transparent display can be a frameless transparent display. This is usually not possible with conventional transparent OLED displays.

The guiding of the image rays in the optical unit from the reflection element to the holographic diffuser can lower the risk of image deterioration, which can result from microparticles in the air in a configuration of a display with free image rays.

The proposed transparent display can be designed for reproducing images with very large dimensions, but at the same time have a particularly low depth. In particular, provision is made for the optical unit with the holographic diffuser and the reflection element to be adapted to the projector such that a viewer perceives a very high-quality, evenly illuminated image.

### BRIEF SUMMARY OF THE FIGURES

Examples are described below with reference to the following figures, in which:

FIG. 1 shows a first transparent display;

FIG. 2 shows a second transparent display;

FIG. 3 shows a third transparent display;

FIG. 4 shows a fourth transparent display;

FIG. 5 shows a fifth transparent display; and

FIG. 6 shows a sixth transparent display.

### DETAILED DESCRIPTION

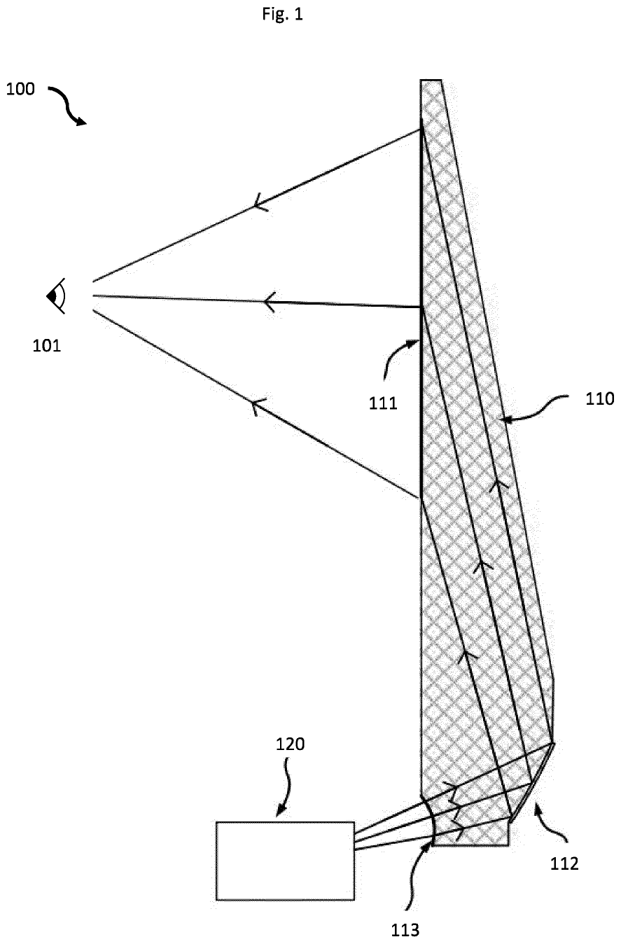

FIG. 1 illustrates a large-format transparent display 100. The transparent display 100 comprises a holographic diffuser 111 extending substantially in a two-dimensional diffuser plane and an enlarging reflection unit 112, wherein the holographic diffuser 111 and the reflection unit 112 are part of a one-piece optical unit 110, and wherein image rays reflected by the reflection unit 112 are guided within the optical unit 110 to the holographic diffuser 111.

A width of the holographic diffuser 111 can be more than 150 mm, in particular more than 250 mm. A height of the holographic diffuser 111 can be more than 100 mm, in particular more than 150 mm. For example, the diagonal of the holographic diffuser 111 can be between 10 inches (25.4 cm) and 100 inches (254 cm). The thickness of the transparent display can be less than 10% of the diagonal of the holographic diffuser. In other words, the thickness of the transparent display 100 may be less than 10% of the image presented by means of the holographic diffuser 111. The thickness of the transparent display 100 may in particular be less than 7%, preferably less than 6%, of the diagonal of the holographic diffuser 111.

The one-piece optical unit 110 may be designed with a thickness decreasing toward the top of the holographic diffuser 111 and/or sides of the holographic diffuser 111, without the guidance of the image rays within the optical unit 110 being affected thereby. The thickness decreasing toward the edges of the holographic diffuser 111 leads to a further slimmer impression of the transparent display 100.

The reflection unit 112 can be designed as a mirror, in particular aspherical mirror.

The transparent display 100 may further comprise a projector 120, wherein the projector 120 comprises a picture generating unit, in particular a “digital micromirror device” (DMD).

The optical unit 110 has an input-coupling element 113, which is designed for coupling image rays generated by the picture generating unit of the projector 120 into the optical unit 110.

The input-coupling element 113 is an optical surface of the optical unit 110. The input-coupling element 113 can be designed as an aspherical surface of the optical unit 110 or as an optical free-form surface.

The curvature of the input-coupling element 113 may be designed in such a way that monochromatic aberrations of the projector 120 and/or the reflection element 112 can be corrected.

The input-coupling element 113 can also be referred to as an input-coupling window. Chromatic aberrations generated due to the dispersion in the substrate of the optical unit 110 and the curvature of the input-coupling window 110 can already be taken into account in the optical design of the projector 120 and thus be balanced in the overall system of the projector 120 and the optical unit 110.

The light source of the projector 120 can be light-emitting diodes (LEDs) or lasers.

The angle of incidence of the image rays on the holographic diffuser 111 may be designed such that zero-order light diffracted by the holographic diffuser 111 cannot pass through the holographic diffuser 111 due to total internal reflection. This zero-order light can be reflected several times in the substrate of the optical unit 110 and leave it at the upper end. There, a prism or a curved surface may be provided to guide this light to a light absorber. The prevention of the passage of zero-order light can be particularly advantageous when a laser is used as the light source of the projector 120 and special protection of the eyes of the viewer 101 from the laser light must be taken into account.

The holographic diffuser 111 may be laminated onto the substrate of the optical unit 110.

In the transparent display 100 shown in FIG. 1, the viewer 101 is located on the same side of the substantially two-dimensional diffuser plane of the holographic diffuser 111 as the projector 120. The holographic diffuser 111 may be arranged on the same side of the optical unit 110 as the projector 120.

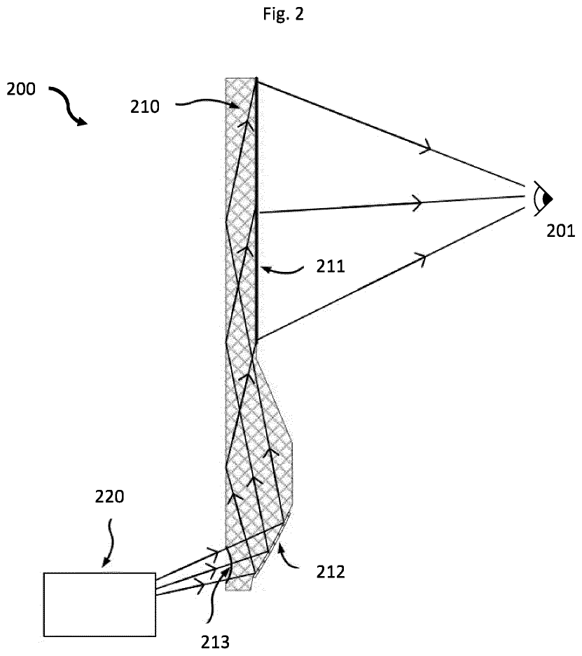

In FIG. 2, a further transparent display 200 is shown. The transparent display 200 in turn comprises an optical unit 210 and a projector 220.

The optical unit 210 comprises a holographic diffuser 211, a reflection unit 212, and an input-coupling element 213. The input-coupling element 213 is provided on a side of the optical unit lying opposite the holographic diffuser 211. In contrast to the transparent display 100 shown in FIG. 1, the transparent display 200 is provided for the projector 220 to be arranged on a side of the viewer 201 lying opposite the diffuser plane.

Image rays reflected by the reflection unit 212 are guided in the transparent display 200 to the holographic diffuser 211 by means of total reflection in the optical unit 210. This can serve for further reducing the thickness of the transparent display 200. The image rays are reflected by the reflection unit 212, which has an enlarging effect, and reflected on the left side of the optical unit 210 by means of total internal reflection before they are incident on the laminated-on holographic diffuser 211. In this case, the total internal reflection can cause substantially loss-free deflection of the image rays to the holographic diffuser 211. The holographic diffuser 211 then diffracts the image rays into the specified eyebox. Thus, the viewer 201 can perceive the image generated by a picture generating unit in the projector 220.

The image rays reflected by the reflection element 212 preferably undergo total internal reflection only once or not at all in the region of the holographic diffuser 211 in the optical unit 210. By dispensing with total internal reflections in the region of the holographic diffuser 211, the risk of unwanted fringe formation in the image perceived by the viewer can be reduced.

In particular, total internal reflection can reduce the thickness of the transparent display 200 by half. The constituent components of the transparent display 200 which are located in FIG. 2 below the holographic diffuser may be arranged so as to be invisible for the viewer 201 in a base of the transparent display 200. The viewer 201 therefore preferably perceives only a borderless transparent panel on which color images are presented.

If the projector 220 uses laser as the light source, the polarization of the image rays emitted by the projector 220 can be adjusted such that they, in combination with the design of the holographic diffuser 211, provide a particularly high-quality image. In particular, the polarization of the light emitted by the projector 220 may be adapted to the holographic diffuser 211.

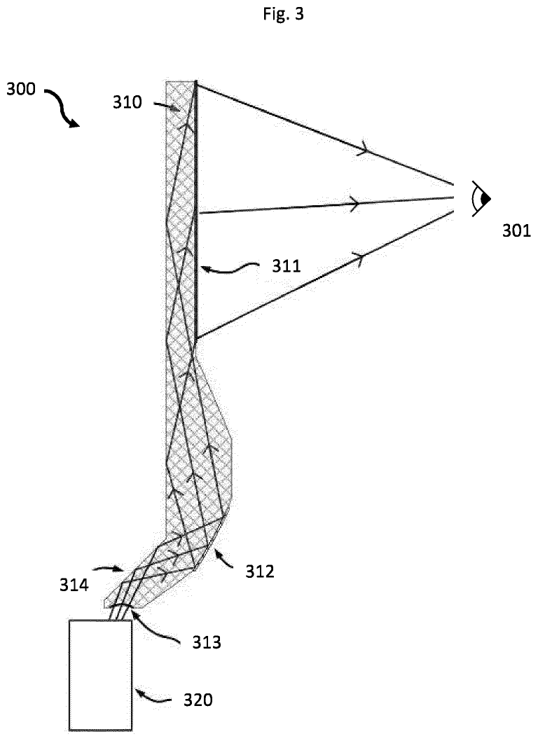

FIG. 3 also illustrates a transparent display 300, which comprises an optical unit 310 and a projector 320. The optical unit 310 comprises a holographic diffuser 311, an enlarging reflection element 312, and an input-coupling element 313.

In addition, the optical unit 310 has a deflection element 314. The deflection element 314 is designed for guiding image rays, coupled by the input-coupling element 313 into the optical unit 310, to the reflection unit 312. In this way, it can be made possible to position the projector 320 below the optical unit 310. This may reduce the thickness of the transparent display 300 further. The deflection element 314 can be designed as a total internal reflection prism, as shown in FIG. 3. However, it is also conceivable to provide a mirror as the deflection element.

The input-coupling elements 113, 213, 313 are designed as input-coupling windows of the respective optical unit 110, 210, 310.

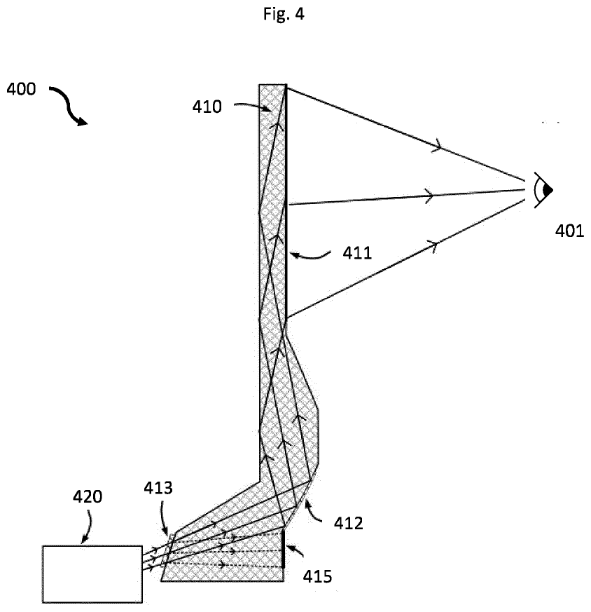

FIG. 4 illustrates a transparent display 400, in which the input-coupling element 413 is designed as a holographic input-coupling element.

Image rays generated by the projector 420 are coupled into the optical unit 410 by means of the input-coupling element 413, which is designed as a holographic input-coupling element. The input-coupling element 413 may be in particular a planar volume holographic element (v-HOE). As shown in FIG. 4, the holographic input-coupling element 413 input-couples the image rays from the projector 420, wherein their direction of propagation is maintained.

The provision of a holographic input-coupling element 413 can have the advantage over an input-coupling window that it is easier to manufacture, especially if a large number of transparent displays are to be produced.

The input-coupling surface of the holographic input-coupling element 413 can be oriented such that the zeroth order of the light diffracted by the holographic input-coupling element 413, which is shown dashed in FIG. 4, is guided to a first absorber element 415 and is absorbed there. This can prevent it from causing unwanted stray light in the optical unit.

The holographic input-coupling element 413 may comprise a plurality of layers of transmission holograms. Each layer can be used to input-couple the image rays in one color. For example, the holographic input-coupling element 413 may have a three-layer structure of three transmission holograms, each transmission hologram being associated with one of three colors, in particular red, green, blue. It is also conceivable to provide a pair of reflection holograms for each color channel in order to increase the efficiency of the input-coupling element 413.

In exemplary embodiments, provision is made for the incoming wavefront to also be manipulated by means of the holographic input-coupling element 413 and for aberrations of the transparent display 400 to be corrected in this way. In particular, it may be possible to correct higher-order aberrations with the holographic input-coupling element by using optically fabricated holograms (OFH) obtained by way of construction beams with free-form wavefronts.

Provision may also be made for the holographic input-coupling element 413 to act as a spectral filter, which couples only light of the desired wavelengths into the optical unit 410, while light with other wavelengths is filtered out and, for example, absorbed with the first absorber 415. This can cause the image rays incident on the holographic diffuser 411 to have the lowest possible bandwidth. This can cause the holographic diffuser 411 to diffract particularly little light into the zeroth order, so that little stray light is produced and the eye safety in particular for the viewer 401 is increased. Such a procedure can be useful in particular when using broadband light sources for the projector (e.g. LEDs).

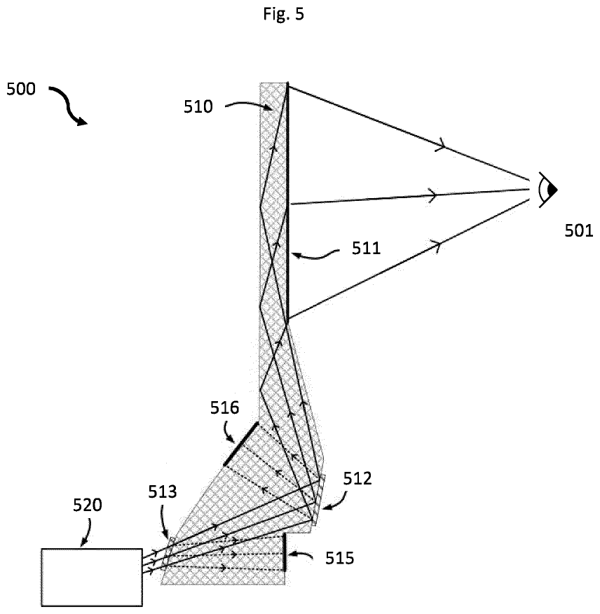

FIG. 5 also illustrates a transparent display 500. The transparent display comprises an optical unit 510 and a projector 520. Image rays generated by the projector 520 are coupled into the optical unit 510 by means of a holographic input-coupling element 513. In this case, the zeroth order of the diffracted light is directed to an absorber 515 by the holographic input-coupling element 513. The first order is directed to the reflection element 512.

In contrast to the reflection elements 112, 212, 312, 412, the reflection element 512 is designed as a holographic reflection element. The holographic reflection element 512 can be substantially planar. Elaborate manufacturing of a curved surface of the optical unit 510, as is necessary for an aspherical mirror, can therefore be omitted.

The holographic reflection element 512 may be in particular a reflection hologram. The angular orientation of the substantially planar reflection element can be selected such that first-order Fresnel reflections, which are shown in FIG. 5 with dashed lines, are guided to a second absorber 516 and are absorbed there. The desired image rays are diffracted by the reflection element 512 such that they are incident on the holographic diffuser 511 after undergoing total internal reflection.

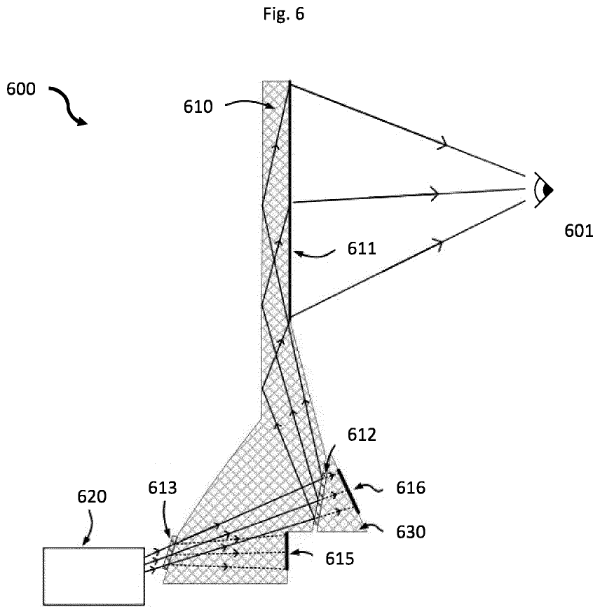

In the transparent display 600 shown in FIG. 6, the zero order of diffraction of the reflection element 612 is output-coupled by means of an output-coupling prism 630 to the right side of the reflection element 612 designed as a reflection hologram and absorbed by the second absorber 616. This may allow the angle at which the reflection element 612 is arranged with respect to the input-coupling element 613 and the holographic diffuser 611 to be chosen more freely.

The holographic reflection element 612 can be constructed with light beams having wavefronts which can be used to correct aberrations of other parts of the transparent display 600. Distortion in particular can be efficiently reduced by adapting the angles of diffraction of the chief rays.

The transparent display 600 may in particular have the advantage that the holographic input-coupling element 613 in combination with the holographic reflection element 612 can cause double spectral filtering of the image rays. Thus, the light that is incident on the holographic diffuser 611 becomes particularly monochromatic for each color channel, as a result of which the diffraction of light in the direction of the zeroth order by the holographic diffuser 611 can be suppressed particularly efficiently.

The various transparent displays proposed herein are characterized in particular by a beam guidance which allows a more uniform illumination with higher intensity of the large-format displays with advantageously low aberrations.

In summary, the following examples are thus disclosed:

Example 1. A transparent display
having a holographic diffuser extending substantially in a two-dimensional diffuser plane, and
having an enlarging reflection element,
wherein the holographic diffuser and the reflection element are part of a one-piece optical unit, and
wherein image rays reflected by the reflection element are guided within the optical unit to the holographic diffuser.

Example 2. The transparent display according to example 1,
wherein a width of the holographic diffuser is greater than 150 mm, in particular 250 mm, and/or
wherein a height of the holographic diffuser is greater than 100 mm, in particular 150 mm.

Example 3. The transparent display according to example 1 or 2,
wherein image rays reflected by the reflection element are guided by means of total internal reflection in the optical unit to the holographic diffuser.

Example 4. The transparent display according to any of the examples 1 to 3,
wherein the reflection element comprises a mirror, in particular an aspherical mirror.

Example 5. The transparent display according to any of the examples 1 to 4,
wherein the reflection element comprises a holographic reflection element.

Example 6. The transparent display according to any of the examples 1 to 3,
wherein the transparent display comprises a projector,
wherein the projector comprises a picture generating unit, in particular a digital micromirror device, DMD,
wherein the optical unit comprises an input-coupling element,
wherein the input-coupling element is designed for coupling image rays generated by the picture generating unit into the optical unit.

Example 7. The transparent display according to example 6,
wherein the input-coupling element is designed for guiding the input-coupled image rays to the reflection element.

Example 8. The transparent display according to either of the examples 6 and 7,
wherein the input-coupling element is designed for coupling divergent image rays into the optical unit.

Example 9. The transparent display according to any of the examples 6 to 8,
wherein the input-coupling element comprises a free-form surface of the optical unit.

Example 10. The transparent display according to any of the examples 6 to 8,
wherein the input-coupling element comprises an aspherical surface of the optical unit.

Example 11. The transparent display according to either of the examples 9 and 10,
wherein the projector is designed for correcting chromatic aberrations induced by the input-coupling element.

Example 12. The transparent display according to any of the examples 6 to 8,
wherein the input-coupling element comprises an input-coupling grating and/or a holographic input-coupling element.

Example 13. The transparent display according to any of the examples 6 to 12,
wherein the input-coupling element is designed for correcting monochromatic aberrations of the projector and/or the reflection element.

Example 14. The transparent display according to any of the examples 6 or 8 to 13,
wherein the optical unit has a deflection element in order to guide image rays coupled by the input-coupling element into the optical unit to the reflection element.

Example 15. The transparent display according to example 14,
wherein the deflection element comprises a total internal reflection prism and/or a mirror.

Example 16. The transparent display according to any of the examples 6 to 15,
wherein the optical unit has a first absorber element;
wherein the first absorber element is designed for absorbing zero-order image rays received from the input-coupling element.

Example 17. The transparent display according to any of the examples 1 to 4 or 6 to 16,
wherein the optical unit has a second absorber element,
wherein the second absorber element is designed for
absorbing zero-order image rays received from the reflection element.

Example 18. The transparent display according to any of the examples 1 to 17,
wherein the holographic diffuser is laminated onto a substrate.

1. A large-format transparent display having a holographic diffuser extending substantially in a two-dimensional diffuser plane, and
having an enlarging reflection element,
wherein the holographic diffuser and the reflection element are part of a one-piece optical unit, and
wherein image rays reflected by the reflection element are guided within the optical unit to the holographic diffuser.

2. The large-format transparent display as claimed in claim 1,
wherein a width of the holographic diffuser is greater than 150 mm, and/or
wherein a height of the holographic diffuser is greater than 100 mm.

3. The large-format transparent display as claimed in claim 1,
wherein the image rays reflected by the reflection element are guided by means of total internal reflection in the optical unit to the holographic diffuser.

4. The large-format transparent display as claimed in claim 3,
wherein the image rays reflected by the reflection element undergo total internal reflection once or not at all in a region of the holographic diffuser in the optical unit.

5. The large-format transparent display as claimed in claim 1,
wherein the reflection element comprises an aspherical mirror.

6. The large-format transparent display as claimed in claim 1,
wherein the reflection element comprises a holographic reflection element.

7. The large-format transparent display as claimed in claim 1,
wherein the transparent display comprises a projector,
wherein the projector comprises a digital micromirror device, DMD,
wherein the optical unit comprises an input-coupling element,
wherein the input-coupling element is designed for coupling the image rays generated by the digital micromirror device into the optical unit.

8. The large-format transparent display as claimed in claim 7,
wherein the input-coupling element is designed for guiding input-coupled image rays to the reflection element.

9. The large-format transparent display as claimed in claim 7,
wherein the input-coupling element is designed for coupling divergent image rays into the optical unit.

10. The large-format transparent display as claimed in claim 7,
wherein the input-coupling element comprises a free-form surface of the optical unit.

11. The large-format transparent display as claimed in claim 7,
wherein the input-coupling element comprises an aspherical surface of the optical unit.

12. The large-format transparent display as claimed in claim 10,
wherein the projector is designed for correcting chromatic aberrations induced by the input-coupling element.

13. The large-format transparent display as claimed in claim 7,
wherein the input-coupling element comprises an input-coupling grating and/or a holographic input-coupling element.

14. The large-format transparent display as claimed in claim 7,
wherein the input-coupling element is designed for correcting monochromatic aberrations of the projector and/or the reflection element.

15. The large-format transparent display as claimed in claim 7,
wherein the optical unit has a deflection element in order to guide image rays coupled into the optical unit by the input-coupling element to the reflection element.

16. The large-format transparent display as claimed in claim 15, wherein the deflection element comprises a total internal reflection prism and/or a mirror.

17. The large-format transparent display as claimed in claim 7,
wherein the optical unit has a first absorber element; and
wherein the first absorber element is designed for absorbing zero-order image rays received from the input-coupling element.

18. The large-format transparent display as claimed in claim 1,
wherein the optical unit has a second absorber element, and
wherein the second absorber element is designed for absorbing zero-order image rays received from the reflection element.

19. The large-format transparent display as claimed in any claim 1,
wherein the holographic diffuser is laminated onto a substrate.
